(19) United States
(12) Patent Application Publication
(10) Pub. No.: US 2009/0309546 A1
(43) Pub. Date: Dec. 17, 2009

(54) System and Method for Charging Batteries

(76) Inventor: Roger Altman, Alexandria Bay, NY (US)

Correspondence Address: THOMPSON HINE L.L.P.;Intellectual Property Group, P.O. BOX 8801, DAYTON, OH, 45401-8801, US

(21) Appl. No.: 12/138,820

(22) Filed: Jun. 13, 2008

(51) Int. Cl. H02J 7/00

(52) U.S. Cl. 320/124; 320/162; 320/132

(57) ABSTRACT

A method for charging a battery including the steps of providing a battery charger, connecting the battery to the battery charger, supplying a charging current to the battery from the battery charger to increase a charge of the battery, and ceasing to supply the charging current to the battery once the charge of the battery has reached a threshold value, wherein said threshold charge value is selected to correspond with a percentage of a full charge of said battery that occurs prior to substantial gassing of said battery.

### BACKGROUND

The present disclosure is directed to systems and methods for charging batteries and, more particularly, systems and methods for charging and discharging motive power batteries in a manner that increases battery life and reduces charger power consumption.

Motive power batteries, such as flooded lead-acid batteries used on lift trucks and the like, typically cycle through three phases. First, the battery is connected to a charger and is charged. A typical charge phase is about eight hours. Second, the battery is rested and permitted to cool. A typical cool-down phase is about eight hours. Finally, the battery is discharged by working the battery in the intended application. A typical discharge phase is about eight hours. Therefore, a single battery application that requires 24-hour operation generally requires three batteries, wherein one battery is being discharged while one battery is being charged and the other battery is in the cool-down phase.

The discharge phase typically takes the battery from a 100 percent charge to, for example, about a 20 percent charge. Batteries are generally not discharged below about 20 percent charge so as not to damage the battery. Therefore, the charge phase applies voltage and current to the discharged battery to raise the charge of the battery from the discharged level (e.g., 20 percent charge) to a 100 percent charge.

However, charging efficiency is not constant during charging. For example, charging efficiency is almost 100 percent when the battery is taken from full discharge (e.g., 20 percent charge) to the beginning of the gassing stage, which typically begins at about the 80 percent charge level for a flooded lead-acid battery. After gassing, the formation of gas and the generation of heat may drop the charging efficiency to below 60 percent as the battery approaches a 100 percent charge.

Gassing occurs when the water decomposition reaction competes with the charging process, thereby impacting charging efficiency. Gassing becomes substantial when noticeable quantities of gas begin to escape from the battery and/or when the charging efficiency is substantially reduced (e.g., drops below about 95 percent).

Therefore, a substantial portion, for example about 45 percent, of the total power necessary to charge a battery is consumed when taking the battery from about an 80 percent charge to a 100 percent charge.

Accordingly, there is a need for a more efficient means for charging batteries without reducing battery life.

### SUMMARY

In one aspect, the disclosed method for charging a battery may include the steps of supplying a charging current to the battery to increase a charge of the battery and ceasing to supply the charging current to the battery once the charge of the battery has reached a threshold charge value, wherein the threshold charge value is a percentage of a full charge of the battery that is substantially less than 100 percent.

In another aspect, the disclosed method for charging a battery may include the steps of supplying a charging current to the battery to increase a charge of the battery and ceasing to supply the charging current to the battery once the charge of the battery has reached a threshold charge value, wherein the threshold charge value is selected to correspond with a percentage of a full charge of the battery that occurs prior to substantial gassing of the battery.

In another aspect, the disclosed method for charging a battery may include the steps of providing a battery charger, connecting the battery to the battery charger, supplying a charging current to the battery from the battery charger to increase a charge of the battery, and ceasing to supply the charging current to the battery once the charge of the battery has reached a threshold charge value, wherein the threshold charge value is typically at or below about 85 percent of full charge.

In another aspect, the disclosed method for charging and discharging batteries may include the steps of providing a first battery and a second battery, supplying the first battery with a charging current to increase a charge of the first battery, ceasing to supply the charging current to the first battery once the charge of the first battery has reached a threshold charge value, wherein the threshold charge value is typically at or below about 85 percent of full charge, during the supplying step, discharging the second battery and, once the second battery is discharged, repeating the supplying and ceasing steps with the second battery while the first battery is being discharged.

In another aspect, the disclosed battery charging system may include a battery application, a battery charger, the battery charger being physically independent of the battery application, a first battery connected to the battery application to supply electrical energy thereto, and a second battery connected to the battery charger to receive a charging current therefrom, the charging current increasing a charge of the second battery and ceasing when the charge of the second battery reaches a threshold charge value, wherein the threshold charge value is typically at or below about 85 percent of full charge, wherein, when the first battery is fully discharged, the first battery is disconnected from the battery application and connected to the battery charger, and the second battery is disconnected from the battery charger and connected to the battery application.

Other aspects of the disclosed system and method for charging batteries will become apparent from the following detailed description, the accompanying drawings and the appended claims.

### BRIEF DESCRIPTION OF THE DRAWINGS

FIG. 1 is a schematic illustration of one aspect of the disclosed system for charging batteries;

FIG. 2 is a graphical illustration of percent charge versus time supplied by the system of FIG. 1; and

FIG. 3 is a flow chart illustrating one aspect of the disclosed method for charging batteries.

### DETAILED DESCRIPTION

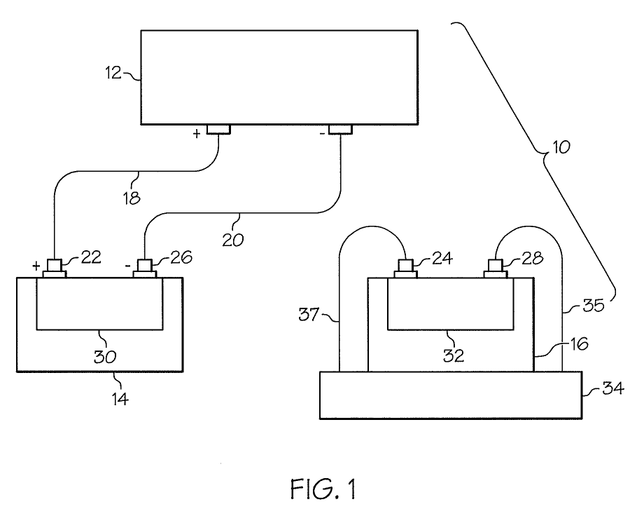

Referring to FIG. 1, one aspect of the disclosed system for charging batteries, generally designated 10, may include a charger 12, a first battery 14 and a second battery 16. The charger 12 may include a positive charging cable 18 and a negative charging cable 20. The charger 12 may be any battery charger capable of supplying a charging current to the batteries 14, 16 by way of, for example, the charging cables 18, 20.

The batteries 14, 16 may be any appropriate rechargeable batteries and may include positive terminals 22, 24 and negative terminals 26, 28. In one aspect, the batteries 14, 16 may be lead-acid batteries, such as flooded lead-acid batteries. In a specific aspect, the batteries 14, 16 may be motive power lead-acid batteries, such as lift truck batteries.

The batteries 14, 16 may have pulsation devices 30, 32 connected thereto to prevent or remove the accumulation of sulfate crystals within the batteries 14, 16. Therefore, the pulsation devices 30, 32 may increase the useful life of the batteries 14, 16 and may help sustain the capacity of the batteries 14, 16. Indeed, it is believed that constantly supplying the batteries 14, 16 with pulsation energy from the pulsation devices 30, 32 may maintain the capacity of the batteries 14, 16 at or near the amp-hour rating of a new battery.

The pulsation devices 30, 32 may be integral with the batteries 14, 16 or may be otherwise connected to (e.g., by way of the terminals 22, 24, 26 28) the batteries 30, 32. However, in an alternative aspect, a single pulsation device (not shown) may be used and may be associated with the charger 12 to supply pulsation energy to the batteries 14, 16 while the batteries 14, 16 are being charged.

The pulsation devices 30, 32 may be any devices capable of delivering high-frequency voltage and current to the batteries 14, 16 in pulses. For example, the pulsation devices 30, 32 may deliver voltage and current to the batteries 14, 16 at a rate of about 10,000 cycles per second. An example of an appropriate pulsation device 30, 32 is the CANADUS® MP-36 available from Canadus Power Systems of Cleveland, Ohio.

The pulsation devices 30, 32 may deliver pulsation energy to the associated battery 14, 16 generally constantly, regardless of whether the battery 14, 16 is in use, at rest, or being charged. However, those skilled in the art will appreciate that the pulsation devices 30, 32 may be activated only periodically, only during certain conditions (e.g., during discharge, cool-down and/or charge), or otherwise. For example, the pulsation devices 30, 32 may be configured to delivery pulsation after charging, as disclosed in U.S. Ser. No. 11/638,714 filed on Dec. 14, 2006, the entire contents of which are incorporated herein by reference.

The first battery 14 may be connected to the charger 12 by connecting the positive cable 18 to the positive terminal 22 of the battery 14 and the negative cable 20 to the negative terminal of the battery 14. While the first battery 14 is charging, the second battery 16 may be discharged by connecting the second battery 16 to the desired battery application 34 (e.g., a lift truck) by, for example, wires 35, 37. Once the second battery 16 has been fully discharged (e.g., a charge of 20 percent of full charge), the first battery 14 may be disconnected from the charger 12 and connected to the battery application 34 such that the second battery 16 may be connected to the charger 12.

The charger 12 may supply charging current to the battery 14, 16 to raise the charge of the battery, but may cease charging before the battery 14, 16 achieves a full charge (i.e., a 100 percent charge). The charger 12 may cease charging the battery 14, 16 when the battery 14, 16 achieves a predetermined threshold charge value. The threshold charge value may be set as a percentage of full charge of the battery 14, 16. In one example, the threshold charge value may be set as 85 percent or less of full charge of the battery 14, 16. In another example, the threshold charge value may be set as 80 percent or less of full charge of the battery 14, 16. In another example, the threshold charge value may be set as 75 percent or less of full charge of the battery 14, 16. The selection of the threshold charge value is discussed in greater detail below.

In one aspect, the threshold charge value may be set based upon an estimation or determination of the beginning of the gassing stage (i.e., the point in the charging phase at which bubbles of hydrogen and oxygen begin to form on the plates of the battery 14, 16). For example, when a particular type of flooded, lead-acid battery begins gassing at about 80 percent of full charge, the threshold charge value may be set at about 80 percent of full charge. Therefore, when the full charge of the battery 14, 16 is at or about the amp-hour rating of the battery 14, 16, the threshold charge value may be expressed as about 80 percent of its amp-hour rating (“PAHR”).

In another aspect, the threshold charge value may be established based upon a threshold loss of charging efficiency. For example, the charger 12 may be programmed to cease charging the battery 14, 16 when the charging efficiency drops below 95 percent. For simplicity, the threshold charging efficiency may be correlated to a percentage of full charge or, if applicable, a PAHR value. For example, charging efficiency below 95 percent may correspond to percent charge of 81 or more and, therefore, the threshold charge value may be set as 81 percent of full charge.

In another aspect, the threshold charge value may be established based upon a percent charge that eliminates the need for an additional battery (e.g., the system may be optimized to use two rather than three batteries). For example, a traditional lift truck battery application usually requires three batteries in a 24 hour period. However, pursuant to the present aspect of the disclosure, if two batteries taken to a charge of, for example, about 85 percent of full charge eliminate the need for a third battery, then the threshold charge value may be set to about 85 percent of full charge. Those skilled in the art will appreciate that using the present disclosure to eliminate the need for an additional battery provides a substantial cost savings and may warrant selecting somewhat higher threshold charge values despite inducing a minimal amount of gassing and some loss of charging efficiency.

In another aspect, the threshold charge value may be established based upon a target temperature increase of the battery. In one example, when the temperature of a particular battery increases 10 percent from room temperature at a charge of about 82 percent of full charge, the threshold charge value may be set as 82 percent of full charge. In another example, when the temperature of a particular battery reaches 95° F. at a charge of about 79 percent of full charge, the threshold charge value may be set as 79 percent of full charge.

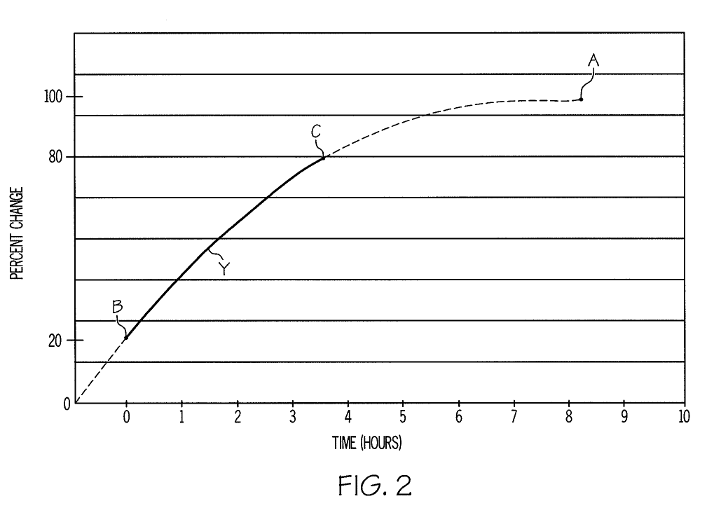

Referring to FIG. 2, percent charge versus time is shown for a flooded, antimonial-lead battery 14,16, referred to herein as the “exemplary battery.” The charging curve Y (part solid line and part broken line) shows that the exemplary battery 14, 16 may be taken from a 20 percent charge (point B) (e.g., full discharge) to a 100 percent charge (point A) after about 8 hours of charging. As can be seen, the charging curve Y is substantially linear between about 20 percent charge (point B) and 80 percent charge (point C). Beyond point C, the charging curve Y, now shown with broken lines, begins to substantially drop off, indicating a substantial drop in charging efficiency. Therefore, point C may be selected as the threshold charge value for the exemplary battery 14, 16.

Thus, when using the exemplary battery 14, 16 for which the charging curve Y is shown in FIG. 2, the threshold charge value may be at most about 85 percent of full charge, preferably about 80 percent of full charge or less, wherein the charger 12 may be configured to cease charging the battery 14, 16 after the battery 14, 16 (or an associated detection device, system or process) has detected the battery 14, 16 as having a charge equal to the threshold charge value.

At this point, those skilled in the art will appreciate that the charging curve Y shown in FIG. 2 is for a specific type of battery, particularly a flooded lead-acid battery, and that different batteries, such as sealed lead-acid batteries, which typically have a different grid composition than flooded lead-acid batteries, will have a different charging curve, thereby requiring the selection of a different threshold charge value.

Furthermore, at this point, those skilled in the art will appreciate that the selection of the threshold charging value (i.e., point C on the charging curve Y) will depend on the particular battery application and can be optimized to satisfy a particular need. For example, setting the threshold charging value too low (e.g., 50 percent charge) may require alternating the batteries too frequently, thereby losing efficiency, while setting the threshold charging value too high (e.g., 90 percent charge) may negatively impact the charging efficiency, which increases costs, and may generate excessive heat, which may require a cool-down period to avoid damaging the battery.

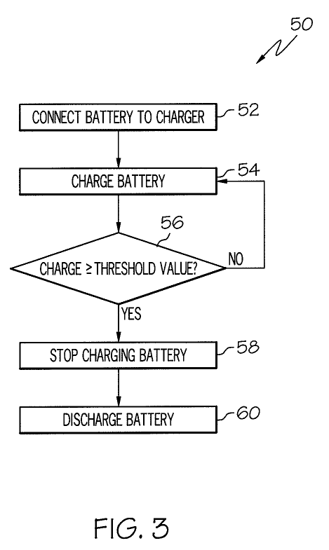

Referring to FIG. 3, one aspect of the disclosed method 50 for charging a battery 14, 16 using the disclosed system 10 may include the following steps. First, as shown by box 52, a battery 14, 16 may be connected to the charger 12. Second, as shown by box 54, the charger 12 may supply a charging current to the battery 14, 16. During charging, the charger 12 or other designated device, may monitor the amount of charge that the battery 14, 16 has received. For example, as shown by box 56, the charger 12 or other designated device may monitor the charge of the battery 14, 16 throughout charging (continuously or periodically) to determine whether the charge has met or exceeded the threshold value (e.g., 80 percent). The charger 12 may continue to charge the battery 14, 16 until the threshold charge value has been obtained. As shown by box 58, the charger 12 may cease charging the battery 14, 16 once the threshold charge value has been obtained, thereby completing the charging phase. Finally, as shown by box 60, the battery 14, 16 is ready for use immediately after charging (i.e., no cool-down period is necessary).

Accordingly, the disclosed system and method for charging batteries eliminates the need for a cool-down period by eliminating the heating that occurs when a battery is charged through the gassing stage. Therefore, the disclosed system and method for charging batteries permits a user to cycle through two (charge and discharge), rather than three (charge, cool-down and discharge), phases, thereby eliminating the need for a third battery per application and the costs associated therewith.

Furthermore, by charging batteries to a threshold charge value that is set based upon the beginning of the gassing stage or the loss of charging efficiency, the disclosed system and method for charging batteries minimizes charger power consumption, thereby substantially reducing operating costs.

Still furthermore, the disclosed system and method may increase battery utilization percentage, which is defined as the average, real world, charge-discharge differential expressed as a percentage of 80 (i.e., the percentage points available by subjecting a new battery to an 80 percent discharge). Battery utilization percentage (“BUP”) may be calculated as follows:

$$BUP = \frac{{C}_{F} - {C}_{D }}{80} \times 100$$

wherein C_{F} is the charge of the battery at the end of the charging phase and C_{D} is the charge of the battery at full discharge.

The disclosed system and method for charging batteries may yield a battery utilization percentage of about 75 percent when the threshold charge value is 80 percent of full charge and the charge of a fully discharged battery is 20 percent (100*(80−20)/80=75). Those skilled in the art will appreciate that the use of pulsation devices may preserve the capacity of the batteries such that full charge may be at or near the amp-hour rating of the batteries. For a comparison to a prior art charging system without pulsation, the average capacity, based upon the inventor's real-world experience, of a fully charged motive power battery in a 3-shift operation is about 85 (PAHR=85) and the average capacity when the battery is fully discharged is about 35 percent (PAHR=35), providing a battery utilization percentage of about 62.5 percent (100*(85−35)/80=62.5). Therefore, the disclosed system and method for charging batteries may actually increase the battery utilization percentage, without the need for charging the battery to full capacity.

Although various aspects of the disclosed system and method for charging batteries have been shown and described, modifications may occur to those skilled in the art upon reading the specification. The present patent application includes such modifications and is limited only by the scope of the claims.

What is claimed is:

1. A method for charging a battery comprising the steps of:
supplying a charging current to said battery to increase a charge of said battery; and
ceasing to supply said charging current to said battery once said charge of said battery has reached a threshold charge value, wherein said threshold charge value is selected to correspond with a percentage of a full charge of said battery that occurs prior to substantial gassing of said battery.

2. The method of claim 1 wherein said threshold value is at most about 85 percent of said full charge of said battery.

3. The method of claim 1 wherein said threshold value is at most about 80 percent of said full charge of said battery.

4. The method of claim 1 further comprising the step of delivering pulsation energy to said battery.

5. The method of claim 4 wherein said pulsation energy is delivered to said battery during said supplying step.

6. The method of claim 4 wherein said pulsation energy is delivered to said battery continuously.

7. The method of claim 4 wherein said pulsation energy is delivered to said battery after said ceasing step.

8. The method of claim 1 wherein said battery is a lead-acid battery.

9. The method of claim 1 wherein said battery is a flooded, lead-acid battery.

10. The method of claim 1 further comprising the step of discharging said battery immediately after said ceasing step.

11. The method of claim 1 further comprising the step of connecting said battery to a battery charger.

12. The method of claim 1 with the caveat that said battery does not undergo a cool-down phase after said ceasing step.

13. A method for charging and discharging batteries comprising the steps of:
providing a first battery and a second battery;
supplying said first battery with a charging current to increase a charge of said first battery;
ceasing to supply said charging current to said first battery once said charge of said first battery has reached a threshold charge value, wherein said threshold charge value is selected to correspond with a percentage of a full charge of said first battery that occurs prior to substantial gassing of said first battery;
during said supplying step, discharging said second battery; and
once said second battery is discharged, repeating said supplying and ceasing steps with said second battery while said first battery is being discharged.

14. The method of claim 13 wherein said threshold value is at most about 85 percent of said full charge of said first battery.

15. The method of claim 13 wherein said threshold value is at most about 80 percent of said full charge of said first battery.

16. The method of claim 13 wherein said threshold value is at most about 75 percent of said full charge of said first battery.

17. The method of claim 13 further comprising the step of delivering pulsation energy to said first battery and said second battery.

18. The method of claim 17 wherein said pulsation energy is delivered to said first battery and said second battery continuously.

19. The method of claim 13 with the caveat that said first battery does not undergo a cool-down phase after said ceasing step.

20. A battery charging system comprising:
a battery application;
a battery charger, said battery charger being physically independent of said battery application;
a first battery connected to said battery application to supply electrical energy thereto; and
a second battery connected to said battery charger to receive a charging current therefrom, said charging current increasing a charge of said second battery and ceasing when said charge of said second battery reaches a threshold charge value, wherein said threshold charge value is selected to correspond with a percentage of a full charge of said second battery that occurs prior to substantial gassing of said second battery,
wherein, when said first battery is fully discharged, said first battery is disconnected from said battery application and connected to said battery charger, and said second battery is disconnected from said battery charger and connected to said battery application.

21. The battery system of claim 20 wherein said battery application is a lift truck.

22. A method for charging a battery comprising the steps of:
supplying a charging current to said battery to increase a charge of said battery; and
ceasing to supply said charging current to said battery once said charge of said battery has reached a threshold charge value, wherein said threshold charge value is a percentage of a full charge of said battery that is substantially less than 100 percent.

23. The method of claim 22 wherein said threshold charge value is at most about 85 percent of said full charge of said battery.

24. The method of claim 22 wherein said threshold charge value is at most about 80 percent of said full charge of said battery.

25. The method of claim 22 wherein said threshold charge value is at most about 75 percent of said full charge of said battery.
